(19) United States
(12) Patent Application Publication
(10) Pub. No.: US 2020/0382492 A1
(43) Pub. Date: Dec. 3, 2020

(54) MULTI-FACTOR NETWORK AUTHENTICATION SYSTEM

(71) Applicant: Wells Fargo Bank, N.A., San Francisco, CA (US)

(72) Inventor: Chris Kalaboukis, San Jose, CA (US)

(21) Appl. No.: 15/498,379

(22) Filed: Apr. 26, 2017

(51) Int. Cl. H04L 29/06

(52) U.S. Cl. CPC H04L 63/0861; H04L 63/083

(57) ABSTRACT

A network security computing system includes a network circuit enabling the network security system to exchange information over a network, a user database configured to store network security information for a plurality of users, and a network security circuit. The network security circuit is configured to receive a request to connect to a local network from a user computing device associated with a user, receive first authentication data comprising an alphanumeric passkey, receive second authentication data related to a user performing a physical action, authenticate the request by comparing the first and second authentication data with verified passkey data stored in the user database and determining that the alphanumeric passkey corresponds to a predetermined alphanumeric passkey and that the physical action corresponds to a predetermined physical action, and authorize connection of the user computing device to the local network based at least in part on the request being authenticated.

### BACKGROUND

Protecting access to a network using traditional symbolic passkeys can be both inconvenient as well as insecure. For example, a user may forget a symbolic passkey and be unable to gain access to a network. To prevent such a situation, the user may save the symbolic passkey on a computing device. But saving the symbolic passkey to a computing device raises security concerns: if the computing device is stolen, for example, an unauthorized user may be able to gain access to the network using the saved symbolic passkey. Additionally, symbolic passkeys may be easily guessed by unauthorized personnel. Thus, it would be beneficial to provide alternative ways to authenticate users attempting to connect to a network.

### SUMMARY

One embodiment relates to a network security computing system. The system includes a network circuit enabling the network security system to exchange information over a network. The system also includes a user database configured to store network security information for a plurality of users. The system also includes a network security circuit. The network security circuit is configured to receive a request to connect to a local network from a user computing device associated with a user. The network security circuit is also configured to receive first authentication data comprising an alphanumeric passkey. The network security circuit is also configured to receive second authentication data related to a user performing a physical action. The network security circuit is also configured to authenticate the request by comparing the first and second authentication data with verified passkey data stored in the user database and determining that the alphanumeric passkey corresponds to a predetermined alphanumeric passkey and that the physical action corresponds to a predetermined physical action. The network security circuit is also configured to authorize connection of the user computing device to the local network based at least in part on the request being authenticated.

Another embodiment relates to a computer-implemented method. The method includes receiving, by a network security computing system, a request to connect to a local network from a user computing device associated with a user. The method also includes receiving, by the network security computing system, first authentication data comprising an alphanumeric passkey. The method also includes receiving, by the network security computing system, second authentication data related to a user performing a physical action. The method also includes authenticating, by the network security computing system, the request by comparing the first and second authentication data with verified passkey data stored in the user database and determining that the alphanumeric passkey corresponds to a predetermined alphanumeric passkey and that the physical action corresponds to a predetermined physical action. The method also includes authorizing, by the network security computing system, connection of the user computing device to the local network based at least in part on the request being authenticated.

Another embodiment relates to a non-transitory computer readable media having computer-executable instructions embodied therein that, when executed by a network security circuit of a network security computing system, causes the network security computing system to perform operations to authorize a request to connect to a local network. The operations include receiving a request to connect to a local network from a user computing device associated with a user. The operations also include receiving first authentication data comprising an alphanumeric passkey. The operations also include receiving second authentication data related to a user performing a physical action. The operations also include authenticating the request by comparing the first and second authentication data with verified passkey data stored in the user database and determining that the alphanumeric passkey corresponds to a predetermined alphanumeric passkey and that the physical action corresponds to a predetermined physical action. The operations also include authorizing connection of the user computing device to the local network based at least in part on the request being authenticated.

### BRIEF DESCRIPTION OF THE DRAWINGS

FIG. 1 is a block diagram illustrating a multi-factor network authentication system, according to an example embodiment.

FIG. 2 is a block diagram illustrating an example embodiment of the multi-factor network authentication system shown in FIG. 1.

FIG. 3 is a block diagram illustrating an example embodiment of a sensing device of the multi-factor network authentication system shown in FIGS. 1-2.

FIG. 4A is a flowchart of a method of establishing a predetermined action as a secondary non-alphanumeric passkey for a network, according to an example embodiment.

FIG. 4B is a flow chart of a method for verifying the eligibility of a set of sensor data for use as a non-alphanumeric passkey, according to an example embodiment.

FIGS. 5A-5C are exemplary depictions of a user computing device used to carry out the method shown in FIG. 4, according to an example embodiment.

FIG. 6 is a flowchart of a method of authorizing a network connection request, according to an example embodiment.

### DETAILED DESCRIPTION

Before turning to the figures, which illustrate example embodiments, it should be understood that this application is not limited to the details or methodology set forth in the following description or illustrated in the figures. It should also be understood that the phraseology and terminology employed herein is for the purpose of description only and should not be regarded as limiting. For example, the embodiments of systems and methods discussed herein may be relevant to any of a variety of circumstances where using additional layers of authentication to control access to a network may be useful.

Referring generally to the figures, systems and methods for authenticating a user of a network using multiple layers of authentication are shown according to example embodiments. A user computing device associated with a user transmits a request to a network agent to connect to a local network implemented by the network agent. Responsive to the received request, the network agent may transmit authentication logic to the user computing device. The authentication logic may cause the user computing device to present the user with an authentication interface requesting the user to input authentication data including at least two levels of authentication into the user computing device. The first level of authentication may include an alphanumeric passkey. The second level of authentication may require the user to perform an action while a sensing device monitors the user. The action may, for example, include emitting a specific sequence of sounds, performing a specific sequence of movements, and the like. The sensing device may be associated with the user computing device or be separate from the user computing device. Responsive to the user computing device receiving the alphanumeric passkey and the sensing device generating sensing data of the user performing the action, the user computing device transmits the authentication data to the network agent. In some embodiments, the network agent is configured to receive the authentication data and to compare the received authentication data to verified authentication data stored in a memory of the network agent to determine if the received authentication data matches a first network security key and a second network security key stored in the memory of the network agent. The first network security may include, for example, a predetermined alphanumeric passkey. The second network security key may include, for example, a predetermined non-alphanumeric passkey. The predetermined non-alphanumeric passkey may include a verified set of sensor data. In some arrangements, only if the received alphanumeric passkey matches the predetermined alphanumeric passkey and if the received sensor data matches the verified set of sensor data will the user computing device be connected to the local network implemented by the network agent. As a result, an unauthorized individual possessing the user computing device will only be able to gain access to the local network if that unauthorized individual is aware of the specific action necessary to create sensing data that matches the predetermined non-alphanumeric passkey.

The embodiments and implementations of the systems and methods disclosed herein improve current network authentication systems by enabling authorized users to select predetermined actions that may be used to provide an additional layer of authentication of the authorized users before authorizing the connection of computing devices to a local network. For example, a user may select a sequence of sounds as a non-alphanumeric passkey. In order to connect a user computing device to the local network in this instance, the user would need to cause the specific sequence of sounds to be emitted (e.g., vocally) while an auditory sensing device (e.g., a microphone) was capturing the emitted sounds. Sound data stored on the user device, for example, may not be used to authenticate the user. The user may only be able to connect to the local network if the user is aware of the required sequence of sounds. Thus, the systems, methods, and computer implementations disclosed improve current network security methods by providing functionalities that are novel and non-obvious over current systems.

The embodiments discussed herein may be relevant to any of a variety of circumstances where controlling access to a network may be useful. For example, in one embodiment, sensor data associated with a predetermined action may be used in the context of authenticating connection to a private local network associated with a home or place of business of a user. In another embodiment, the sensor data may be used in the context of authorizing connections to networks in a more public setting (e.g., networks associated with municipalities, a wireless hotspot, etc.).

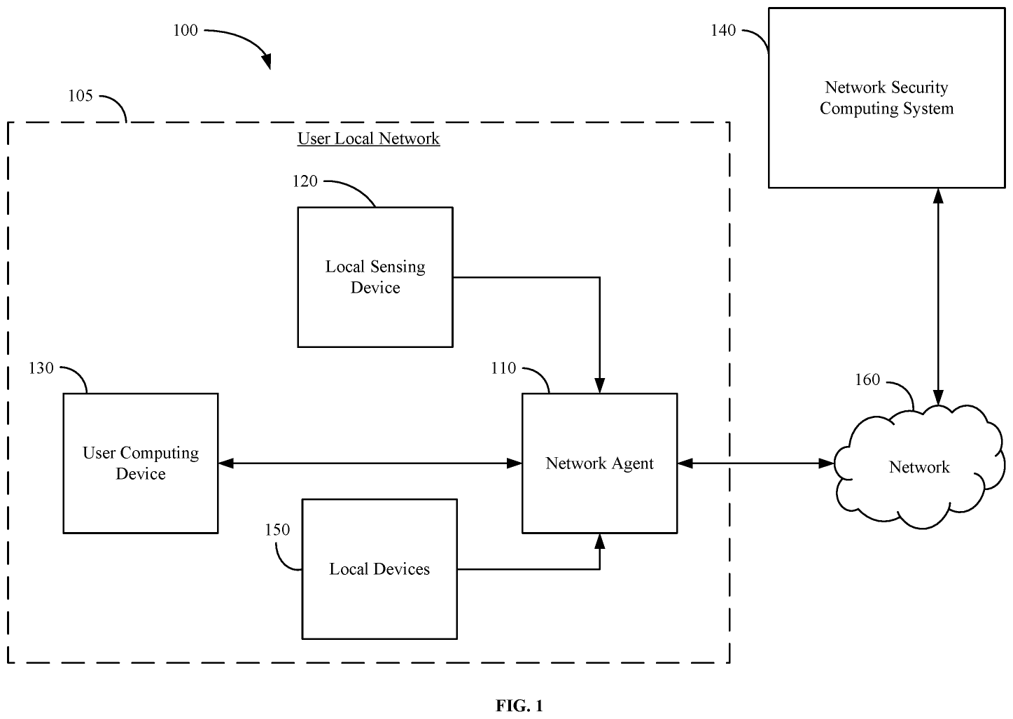

Referring to FIG. 1, a block diagram of a multi-factor network authentication system 100 is shown according to an example embodiment. As described in further detail below, the multi-factor network authentication system 100 facilities enhanced security of a user local network 105 by providing additional factors of non-alphanumeric authentication. The network security system 100 includes a network agent 110, a user computing device 130, a LS device 120, a network security computing system 140, and local devices 150. Various components of the network security system 100 may be configured to communicate over the network 160. The network 160 is a data exchange medium, which may include wireless networks (e.g., cellular networks, Bluetooth®, WiFi, Zigbee®, etc.), wired networks (e.g., Ethernet, DSL, cable, fiber-based, etc.), or a combination thereof. In some embodiments, the network 160 includes the internet.

The network agent 110 is a device configured to generate the user local network 105 through being communicatively coupled to the network 160. In some arrangements, the network agent 110 may include devices designed to facilitate wired networks such as a hub, switch, bridge, router or the like. In some arrangements, the network agent 110 is a wireless router configured to communicate information over the network 160 and to generate wireless signals that are broadcasted to create the user local network 105.

The network agent 110 includes hardware that broadcasts a wireless network signal capable of being received by external computing devices to facilitate the connection of the external computing devices to create the user local network 105. In some arrangements, the wireless network signal broadcasted by the network agent 110 may generate a wireless personal area network (WPAN), and include, for example, a Bluetooth® radio signal or infrared signal. In some arrangements, the wireless network includes a WiFi signal, a WiMAX signal, wireless WAN signal, or the like. The wireless network signal broadcasted by the network agent 110 is received by other computing devices, such as user computing devices 130 and local devices 150. Upon receiving the wireless network signal from the network agent 110, the other devices may be authenticated by the methods disclosed herein to gain greater access to the user local network 105. For example, upon authenticating a user via the user computing device 130, encryption keys may be exchanged between the user computing device 130 and the network agent 110 enabling the user computing device 130 to exchange information with other devices communicating with the network agent 110 such as local devices 150. In some embodiments, the network agent 110 provides external devices with access to an external network (e.g., the network 160). It should be noted that the network agent 110 may perform any of the functionalities attributed to the network security computing system 140 described herein.

The local sensing (“LS”) device 120 is a device configured to monitor a user while the user takes predetermined actions at a time that the user wishes to establish a connection with the user local network 105. The LS device 120 may include any type of equipment capable of capturing and transmitting data that bears any sort of relationship to a user action. The LS device may include a computing device, a smartphone, a camera, a three dimensional image scanner, a motion sensor, an audio sensor, a radar, a wireless beacon, or the like. In some embodiments, the LS device 120 may be a stationary object associated with the place (e.g., a home or place of business) with which the user local network 105 is associated. Alternatively, the LS device 120 may be a part of the user computing device 130. In various arrangements, LS device 120 is configured to exchange information with the user computing device 130 and network agent 110 via the user local network 105. In some arrangements, the LS device 120 is configured to exchange information with the network security computing system 140 via the network 160 through its connection to the user local network 105. For example, the LS device 120 may be configured to transmit generated sensor data of predetermined actions of the user to the network agent 110 upon the LS device 120 capturing sensor data. In some embodiments, the user computing device 130 is the LS device 120 and no additional sensing devices are used (e.g., if the user computing device 130 is a smartphone, an additional sensing device may not be required).

The user computing device 130 is a computing system associated with an authorized user of the user local network 105. In some embodiments, the user may be an entity who owns or is associated with the network agent 110, and may include an individual, business, organization, or the like. The user computing device 130 includes one or more processors and non-transitory storage mediums housing one or more logics configured to enable the user computing device 130 to exchange data over the network 160, execute software applications, access websites, generate graphical user interfaces, and perform other similar operations. Examples of the user computing device 130 include a personal computer such as a desktop or laptop computer, smartphones, tablets, wearable computing devices such as smartwatches, and the like. In some embodiments, the user computing device 130 may communicate with the network agent 110 to enable the user to authenticate a request to connect to the user local network 105. As such, the user computing device 130 may be configured to cooperate with the LS device 120 to prepare and transmit authentication information that is ultimately received at network agent 110 or the network security computing system 140. In one embodiment, the user computing device 130 may be configured to transmit information received from the user, such as an alphanumerical passkey or sensor data, to the LS device 120 to be relayed to the network security computing system 140 via the network 160 along with any sensor data generated by the LS device 120. Thus, in one exemplary embodiment, both the generated sensor data and the alphanumeric passkey may be used to authenticate the request to connect to the user local network 105.

In some embodiments, the user computing device 130 is configured to manage at least one non-alphanumerical passkey that provides access to the user local network 105. For example, the user computing device 130 may include one or more circuits configured to, as will be discussed in further detail below, generate verified sensor data of the user performing a predetermined action to enable the action to be used in an authentication layer for the user local network 105. In addition to capturing verified sensor data, the user computing device 130 may also include one or more circuits configured to receive user preferences with respect to each predetermined action. For example, the user may set preferences to be associated with each predetermined action that set limitations on when the predetermined action may be used to gain access to the user local network 105. Limitations may identify, for example, certain devices that may be connected using the predetermined action, times when the predetermined action may be used to gain access to the user local network 105, and like. For example, the user may generate sensor data of a predetermined sound sequence with a microphone included on the user computing device 130 to set the sound sequence as a non-alphanumeric passkey for the user local network 105. The user may further configure the sensor data of the sound sequence to only work as a non-alphanumeric passkey in certain hours of the day. Thus, if the user attempts to connect to the user local network 105 by emitting the sound sequence at a time outside of those certain hours, the user will be unable to access the user local network. In some embodiments, the user computing device 130 is configured to transmit user preferences to the network agent 110 for storage so that the preferences can be retrieved for use in a connection authentication

The network security computing system 140 is a computing system associated with an entity providing network services to the user. It may be associated, for example, with a network service provider, or any institution that provides services to the user over the network 160, such as financial institutions, service providers, social media companies, and the like. In some arrangements, the network security computing system 140 is configured to receive data over the network 160 from the network agent 110, LS device 120, or the user computing device 130. For example, the network security computing system 140 may be configured to receive sensing data generated by the LS device 120 as well as any information input by the user into the user computing device 130 and to compare the received information to information stored at the network security computing system 140 to authenticate the user. Once the user is authenticated, the network security computing system 140 may be configured to transmit an authentication message to the network agent 110 indicating that the user is authenticated, so that that the network agent 110 may enable the user computing device 130 to access the user local network 105.

Local devices 150 are devices that are located at or otherwise associated with the location of the user local network 105. Local devices 150 may include any device capable of exchanging information via the user local network 105. As such, local devices 150 may include one or more processors and non-transitory storage mediums housing one or more logics configured to enable the local devices 150 to exchange data over the network 105, execute software applications, generate graphical user interfaces, and perform other similar operations. Examples of local devices 150 include smart appliances, smart televisions, smart thermostats, smart vehicles, and computing devices other than the user computing device 130. In some embodiments, authorized users may communicate with the local devices 150 via the user local network 105 using the user computing device 130. For example, one local device 150 may be a smart thermostat (e.g., a Nest® thermostat) enabling the user to set various preferences (e.g., a set point for an HVAC system) using the user computing device 130 via a connection with the user local network 105 that is authenticated via the methods disclosed herein.

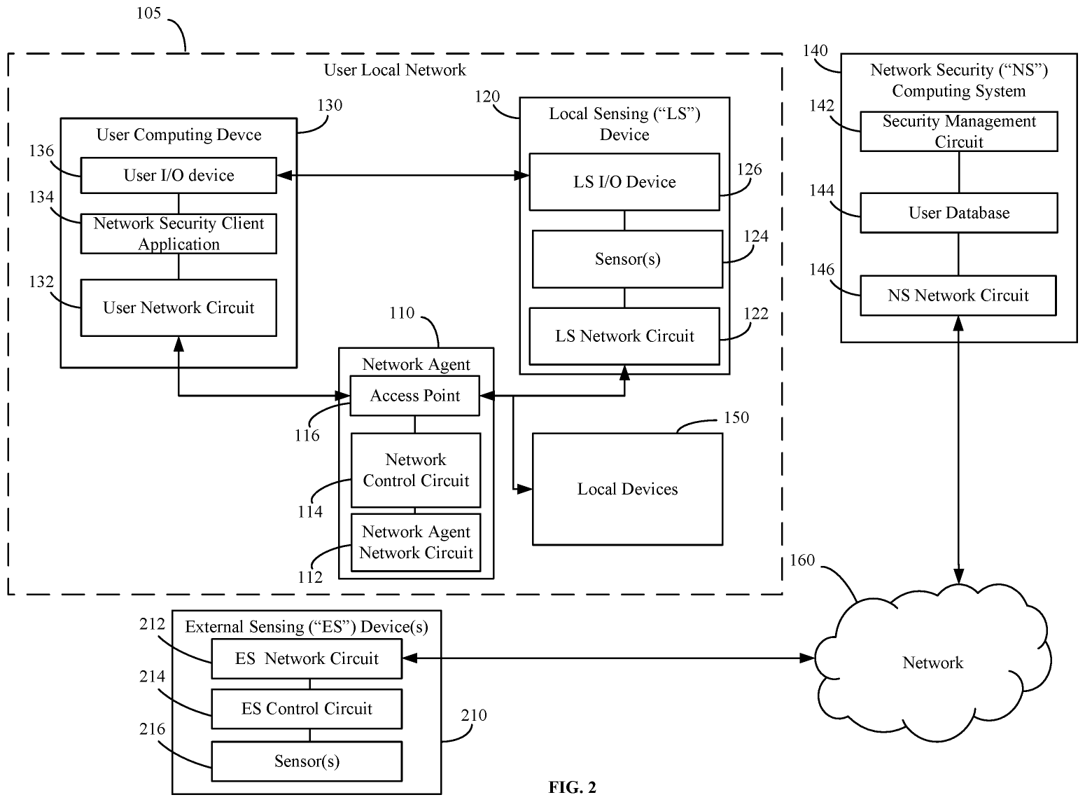

Referring now to FIG. 2, a network security system 200 is shown as a more detailed embodiment of the multi-factor network authentication system 100 and further includes an external sensing (“ES”) device 210. In some arrangements, the ES device 210 is a sensing device attached to a vehicle, such as a drone or an automobile, configured to receive instructions from the network security computing system 140 and/or network agent 110. The system 200 includes example embodiments of the network agent 110, LS device 120, user computing device 130, network security computing system 140, local devices 150, and network 160 of FIG. 1.

The ES device 210 is a device associated with the network security computing system 140. The ES sensing device 210 performs operations with respect to capturing sensing data of actions performed by users seeking to connect to various user local networks. In some arrangements, the ES device 210 includes a movable device such as a vehicle. In various embodiments, the ES sensing device 210 may be attached to an automobile (e.g., a traditional car or a driverless car), an airborne vehicle (e.g., a drone), or an orbital vehicle (e.g., a satellite).

ES device 210 includes ES network circuit 212 enabling the ES device 220 to communicate with ES control circuit 214 and sensors 216 over the network 160. In some embodiments, the ES control circuit 214 is configured to receive instructions from the network security computing system 140 over the network 160 via the ES network circuit 222. These instructions may, for example, identify a location at which the ES device 210 is configured to generate data, identify a set of sensors 216 configured to generate data, as well as an expected non-alphanumeric passkey that is to be received when the sensors 216 sense the user performing at least one action. In some arrangements, the instructions comprise a radio control signal continuously transmitted from the network security computing system 140 configured to position the ES device 210 such that sensors 216 can generate data of actions performed at a predetermined geographic location. Responsive to the received instructions, the ES control circuit 214 is configured to activate various hardware components (not shown) in the ES device 210 to position the ES device 210 to generate the designated non-alphanumeric passkey data. In some arrangements, where the ES device 210 comprises a satellite system, for example, the instructions received from the network security computing system 140 may cause the ES device 210 to focus various sensors 216 located thereon to a specific geographical location.

The sensors 216 are configured to acquire data regarding at least one action of the user responsive to any instructions received via the ES control circuit 214. In some arrangements, sensors 216 are mounted on the ES device 210 and may include any sensing device of sufficient durability to withstand, depending on the arrangement, satellite atmospheric conditions, drone travel, or travel by road. Exemplary sensors 226 include a camera, a microphone, a thermal imaging device, an infrared radiation detector, a motion sensor, a lidar device, a radar device, an ultrasound device, a gyroscope, a piezoelectric sensor, and so on.

In some arrangements, the ES device 210 comprises a radio-controlled vehicle, such as a drone. The ES device 210 is configured to respond to a notification transmitted over the network 160 from another computing device, such as the network agent 110, user computing device 130, the local network sensing device 120, the local devices 150, or the network security computing system 140. In an exemplary embodiment, when the user computing device 130 comes within range of the wireless network signal broadcast by the access point 116 of the network agent 110, the network agent 110 (e.g., via the network control circuit 114), is configured to transmit a notification, including a unique network identifier over the network 160 to the network security computing system 140. Responsive to this received notification, the network security computing system 140 (e.g., via the security management circuit 142) is configured to transmit location information and data-generate instructions concerning the user local network 105 to the ES device 210. In this example, the user, through a process to be described in greater detail below, has established a user image as a non-alphanumeric passkey. Thus, the data-generate instructions transmitted to the ES device 210 by the network security computing system 140 instructs the ES device 210 to travel to a location associated with the user local network 105, and then generate an image of the user to be compared with user information stored in a database (e.g., the user database 144) at the network security computing system 140 for user authentication.

In the system 200, the network agent 110 is configured to generate the user local network 105. As shown in FIG. 2, the network agent 110 comprises a wireless router that includes an access point 116, a network control circuit 114 and a network agent network circuit 112. The network agent network circuit 112 enables the network agent 112 to connect to the network 160 so as to receive signals that are capable of generating the access point 116. The access point 116 receives signals received via the network circuit 112 and generates a wireless signal including a unique network identifier capable of being received by other computing devices such as local devices 150, the user computing device 130, and the LS device 120.

The network control circuit 114 may be a set of instructions stored in the memory (not shown) of the network agent 110. In some arrangements, the instructions include logics that are structured such that, when they are executed by a processor (not shown) of the network agent 110 cause the processor to perform various functions that manage the user local network 105. These functions may include, for example, managing a traditional alphanumerical passkey that must be input into any user computing device to gain full access to the user local network 105.

In some embodiments, the network control circuit 114 is also configured to manage a non-alphanumeric passkey established by the user. For example, the network agent 110 may have data stored thereon consisting of sensor data generated of the user performing a predetermined action that the user has established as a non-alphanumeric passkey. In some arrangements, the network control circuit 114 is configured to authenticate a request received from the user computing device 130 to gain full access to the user local network 105. For example, a particular user may bring the user computing device 130 within the range of the wireless signal broadcasted by the access point 116 and establish a connection to network agent 110. At this point, the user may select the user local network 105 on the user computing device 130, and input a first set of authentication credentials (e.g., an alphanumerical passkey) and request to gain full access to the user local network 105. Responsive to receiving this request, the network control circuit 114 may transmit an authorization signal to the user computing device 130, which may cause the user computing device 130 to present the user with a graphical user interface. The graphical interface may prompt the user to input a non-alphanumeric passkey by activing a sensing device (e.g., the LS device 120) and performing a predetermined action that is monitored by the activated sensing device. The network control circuit 114 may be configured to receive the data obtained by the activated sensing device, and compare the received sensor data to the established non-alphanumeric passkey, and authenticate the user if the received sensor data matches the established passkey and authorize the user computing device 130 to gain full access to the user local network 105.

In some arrangements, the network control circuit 114 is configured to receive sensor data (e.g., via the network agent network circuit 112) and transmit the received sensor data over the network 160 to the network security computing system 140 for authentication. The network control circuit 114 may also be configured to receive an authentication signal from the network security computing system 140, and authorize the user computing device 130 to connect to the user local network 105 responsive to receiving the authorization signal.

The local sensing (“LS”) device 120 includes LS network circuit 122 enabling the LS device 120 to communicate data over the network 160, a sensor 124, and a LS input output (“I/O”) device 126. The LS I/O device 126 includes hardware and associated logics configured to enable the LS device 120 to exchange information with a user. An input aspect of LS I/O device 126 allows the user to provide information to the LS device 120, and may include, for example, a mechanical keyboard, a touchscreen, a microphone, a camera, a fingerprint scanner, any user input device engageable to the LS device 120 via a USB, serial cable, Ethernet cable, and so on. An output aspect of the LS I/O device 126 allows the user to receive information from the LS device 120, and may include, for example, a digital display, a speaker, illuminating icons, LEDs, and so on. The LS I/O device 126 may be configured to include assemblies that serve both input and output functions, allowing the user computing device 130 and the network agent 110 to exchange information with LS device 120. Such assemblies include, for example, radio frequency transceivers (e.g., RF or NFC-based transceivers) and other short range wireless transceivers (e.g., Bluetooth™, laser-based data transmitters, etc.).

The sensors 216 are configured to generate data regarding at least one action of the user. In some arrangements, the sensors 216 are separate from any sensing devices located on the user computing device 130. Sensors 216 may include wearable computing devices as well as structure-mounted devices mounted, for example, on the outside or inside of a home or on a property. In various other example embodiments, the sensing device 216 may include a geo-fence producing radio beacon, a microphone, a motion sensor, a lidar device, a radar device, an ultrasound device, a gyroscope, a pitot tube, a piezoelectric sensor, and so on. The sensor 124 may be a security camera, motion detector, and the like.

In some arrangements, the at least one action performed by the user that constitutes a non-alphanumeric passkey constitutes a series of movements with respect to at least one LS device 120. For example, the LS device 120 may include a camera that generates digital video data of the user performing at least one action, and transmits the video data over the network 160 to the network security computing system 140 for authentication purposes. In some arrangements, multiple sensors 214 generate data relating to movements of the user. For example, as will be described below, the sensors may include a plurality of beacons, each of which transmits unique beacon identifier within a limited geographical range. These unique beacon identifiers may be associated with particular location information stored in the network security computing system 140 or the network agent 110. When the user computing device 130 comes within range of a first beacon, the user computing device 130 receives a first unique identifier, and a signal is transmitted by the beacon (e.g., by the LS network circuit 122) over the network 160 to the network security computing system 140, so that a precise location of the user computing device 130 is known. The user then moves the user computing device 130 so that it receives a second unique beacon identifier and additional location information is transmitted to the network security computing system 140. In some arrangements, the non-alphanumeric passkey constitutes a particular series of location information (e.g., beacon identifiers) being transmitted to the network security computing system 140. Thus, in order to gain access to the user local network 105, the user may have to move the user computing device 130 such that a predetermined sequence of beacon identifiers is transmitted to the network agent 110 or the network security computing system 140 (e.g., by walking in a predetermined path such as a zig-zag pattern or by walking up to a pre-identified landmark such as a tree).

In some arrangements, the multi-factor network authentication system 200 includes multiple types of LS devices 120 that work cooperatively with one another to authenticate requests to connect to the user local network 105. For example, a first LS device 120 may include a low energy beacon that broadcasts a wireless signal within a limited range. In some arrangements, the low energy beacon is configured to detect when the user computing device 130 comes within the range of the wireless signal broadcasted by the low energy beacon, and to transmit a notification signal to a second LS device 120. The second LS device 120 may include any type of sensing device capable of capturing data performing a predetermined action (e.g., a camera, a microphone, an image scanner, etc.). In some arrangements, responsive to receiving the notification signal from the first LS device 120, the second LS device 120 is configured initiate a sequence to monitor the user performing the predetermined action. For example, the second sensing device 120 may present an indication to the user (e.g., via the LS I/O device 126) informing the user that it is necessary for the user to perform a predetermined action while the second LS device 120 monitors the user. In some arrangements, the indication may enable the user to activate the sensors 124 of the second LS device 120. Responsive to the user activing the sensors 124 of the second LS device 120, the second LS device 120 monitors the user performing the predetermined action. Once the user completes the predetermined action, the second LS device 120 may be configured to transmit the generated sensor data to the network agent 110 so that the user may be authenticated using a non-alphanumeric passkey. In some arrangements, triggering an LS device 120 causes a notification to be transmitted to the network agent 110, which may then initiate a sequence to cause the ES device 210 to generate data regarding performance of a predetermined action by the user.

In the system 200, the user computing device 130 is a computing device associated with the user. It includes a user network circuit 132 enabling the user computing device 130 to connect to the network 160, a network security client application 134, and a user I/O device 136. The user I/O device 136 includes hardware and associated logics configured to enable the user computing device 130 (e.g., via hardware that corresponds to that discussed above with reference to the LS I/O device 126) to exchange information with the user and other computing devices.

The network security client application 134 is communicably coupled to network security computing system 140 (e.g., the network security network circuit 146, security management circuit 142, or the user database 144) and is structured to permit the user to manage multiple factors of authentication associated with the user local network 105. In some embodiments, network security client application 134 is a separate software application implemented on the user computing device 130. The network security client application 134 may be downloaded by the user computing device 130, hard coded into the memory of the user computing device 130, or be a web-based interface application such that the network security client application 134 may provide a web browser to the application, which may be executed remotely from the user computing device 130. In the latter instance, the user may have to log onto or access the web-based interface before usage of the network security client application 134. Further, and in this regard, the network security client application 134 may be supported by a separate computing system including one or more servers, processors, network circuits, etc. that transmit applications for use to the user computing device 130. In certain embodiments, the network security client application 134 includes an API and/or a software development kit (SDK) that facilitate the integration of other applications with the network security client application 134. For example, in some arrangements, the network security client application 134 includes an API that communicatively couples the network security client application 134 to a social media client application implemented on the user computing device 130 such that the user may access the network security client application by using social media account information (e.g., a username, password, and the like).

In some arrangements, the network security client application 134 is configured to receive sensor data generated by the LS device 120. For example, in some arrangements, the network security client application 134 is configured to communicatively couple the user computing device 130 with the LS device 120 via the user I/O device 136 and the LS I/O device 126 (e.g., by NFC communication, Bluetooth connection, etc.) such that the user computing device 130 transmits information to the LS device 120 or receives information from the LS device 120. For example, in a non-alphanumerical passkey generation process described herein, the user computing device 130 may be configured to receive data generated by a sensor 124 of the LS device 120 so as to create a non-alphanumerical passkey for authenticating users of the local network 105. In some arrangements, the network security client application 134 is configured to transmit information input by the user into the user computing device 130 (e.g., an alphanumeric passkey, a preference to connect to the user local network, etc.) or information generated by a sensing device associated with the user computing device 130 to the LS device 120.

Irrespective of the form of the network security client application 134, the network security client application 134 is structured to provide displays to the user computing device 130 that enable the user to input information concerning security of the user local network 105. Displays may instruct the user, for example, to set up both an alphanumerical passkey as well as a non-alphanumerical passkey. For example, while the user computing device 130 is connected to the network 160 via a wireless connection to the network agent 110, the network security client application 134 may be configured to activate a sensor associated with the user computing device 130 (e.g., a camera, microphone, accelerometer, or the like) and present the user with a display that instructs the user to perform at least one action while being monitored by the activated sensing device to create a non-alphanumeric passkey. To illustrate, the network security client application 134 may activate a microphone associated with the user computing device 130 and instruct the user to make a sound or a series of sounds (e.g., sing a song, recite a word, a sequence of words, say a phrase, hum a tune, etc.).

In another example, the user may select the type of action to perform and the sensor to generate the data. For example, the user may select to use an accelerometer on the user computing device 130, and the network security client application 134 may activate the accelerometer and instruct the user to move the user computing device 130 to establish a movement pattern as a non-alphanumeric passkey. In another example, the user may select to take a still image, activate a camera on the user computing device 130, and take a still image while taking a specific pose or while having a particular facial expression. Alternatively, the user may select to take a video, activate the camera on the user computing device 130, and take a video while performing an action (e.g., a series of poses, an action sequence, a combination of a movement and a sound, etc.). In another example, the user may select to user voice recognition as a secondary, non-alphanumeric passkey. In such a case, the network security client application 134 may activate a microphone on the user computing device 130 and instruct the user to make a predetermined sequence of sounds. The predetermined sequence of sounds may be pre-selected to obtain enough information regarding the user's voice (e.g., a frequency distribution) to enable the network agent 110 and/or network security computing system 140 to recognize the voice of the user at a later time. As such, the exact sequence of sounds emitted by the user is not used as a non-alphanumeric passkey, but the underlying characteristics of the voice of the user.

After the user performs the action while being monitored by the sensor, the network security client application 134 may be further configured to store the generated sensor data in a memory of the user computing device 130 and to transfer the generated sensor data to the network agent 110 for further processing. In some embodiments, the user is not prompted to input the non-alphanumeric passkey. Rather, the user must initiate the sequence by providing an input to access the user local network 105.

In some arrangements, the network security client application 134 may be configured to present the user with displays that enable the user to gain full access to the user local network 105. For example, when the user brings the user computing device 130 within the range of the wireless signal broadcasted by the network agent 110 and selects the user local network 105, the network security client application 134 may present the user with a display requesting the user to input both an alphanumeric passkey and a non-alphanumeric passkey. In some arrangements, while the user is presented with the display requesting the passkeys, the network security client application 134 may be configured to communicatively couple the user computing device 130 to the LS device 120 such that the user computing device 130 may transmit information to the LS device 120. The displays may instruct the user to enter the second non-alphanumeric passkey by performing a predetermined action while sensors 124 of the LS device 120 generate data of the predetermined action (e.g., make a hand signal, move in a certain way, walk in a particular pattern such as a zigzag or to a landmark such as a tree, etc.). The displays may instruct the user to enter the first alphanumeric passkey by inputting symbols into the user computing device 130 via the user I/O device 136. In some arrangements, the first alphanumeric passkey received via the user I/O device 136 is transmitted to the LS device 120 which may be configured to package the first alphanumeric passkey with the generated sensor data of the predetermined action into an authentication message and transmit the authentication message to the network agent 110 for processing.

The network security (“NS”) computing system 140 includes a security management circuit 142, a user database 144, and a NS network circuit 146 enabling the NS computing system 140 to exchange data over the network. The user database 144 allows the network security computing system 140 to retrievably store customer information relating to the various operations discussed herein, and may include non-transient data storage mediums (e.g., local disc or flash-based hard drives, local network servers, and the like) or remote data storage facilities (e.g., cloud servers). The user database 144 includes personal customer information (e.g., names, addresses, location information, and the like), as well as customer network information (e.g., such as the unique network identified transmitted by the network agent 110, and any security settings that the user has set to control the network agent 110).

In some arrangements, the user database 144 further includes non-alphanumeric passkey information. The user database 144 may store any information acquired by the LS device 120, the ES device 210, or sensing devices associated with the user computing device 130 generated during the processes discussed herein. For example, the user database 144 may store sensor data obtained by a sensing device associated with the user computing device 130 generated during the process by which the user establishes a non-alphanumeric passkey discussed herein. The user database 144 may also store user sensing device information identifying a particular LS device 120 that the user has installed in the premises corresponding to the user local network 105. For example, in an embodiment where a series of low-energy beacon devices are installed, as described herein, the user database 144 may store specific location information for each beacon and associate that location information with a unique beacon identifier associated with each beacon. In other arrangements, where an ES device 210 is incorporated into the system 200, the user database 144 may include additional information for instructing the ES device 210, such as location information for instructing the ES device 210 where to travel.

In some arrangements, the user database 144 also stores general non-alphanumeric passkey information not pertaining to any particular user. In some embodiments, this general non-alphanumeric passkey information includes a set of common sets of sensor information for a plurality of different types of sensors. For example, in the case of audio sensor data, the general non-alphanumeric passkey information includes data indicative of a plurality of sounds, such as monotones, or words said in different ways. In a different example, in the case of accelerometer sensor data, the user database 144 may have a plurality of sets of accelerometer data, corresponding to sets of movements stored thereon. As discussed below, this general non-alphanumeric passkey information is useful in assessing the strength of any non-alphanumeric passkey that the user wishes to establish.

The security management circuit 142 is configured to manage the non-alphanumeric passkeys. In some arrangements, the security management circuit 142 is configured to establish a predetermined user action as a non-alphanumeric passkey. In this regard, the security management circuit 142 is configured to receive an indication that the user wishes to establish a non-alphanumeric passkey from the user computing device 130 over the network 160 via the network circuit 132. Responsive to this received indication, the security management circuit 142 is configured to transmit a graphical interface to the user over the network 160 prompting the user to perform at least one action while being monitored by at least one sensing device. Further, the security management circuit 142 is also configured to receive, over the network 160 via the network circuit 146, sensor data indicative of a user action monitored by at least one sensing device (e.g., the LS device 120). This sensor data may also include a unique network identifier associated with the user local network 105 (e.g., broadcasted by the network agent 110). The security management circuit 142 may be further configured to compare the received sensor data to general non-alphanumerical passkey information (e.g., describing common movement patterns, common sound sequences, and the like) stored in the user database 144 discussed above to determine whether the received sensor data is capable of being a reliable non-alphanumerical passkey. In some arrangements, responsive to determining that the received sensor data contrasts with the general non-alphanumerical passkey information to enough of an extent to be a reliable non-alphanumerical passkey, the security management circuit 142 is configured to store the sensor information in the user database in association with the network identifier in the user database 144.

In some arrangements, the security management circuit 142 is configured to authorize the user computing device 130 to connect to the user local network 105. In this regard, the security management circuit is configured to receive sensor data generated by at least one sensor device (e.g., the LS device 120) associated with a network identifier, retrieve verified non-alphanumeric passkey information stored in the user database 144 associated with the identified local network 105, and determine whether the received sensor data matches the stored verified non-alphanumerical passkey information. In some arrangements, responsive to determining that the received sensor data matches the stored verified non-alphanumerical passkey information, the security management circuit is configured to transmit instructions to the network agent 110 to enable the user computing device 130 to access the user local network 105.

Once the user inputs a non-alphanumerical passkey that matches the verified non-alphanumerical passkey information stored at the network security computing system 140 or the network agent 110, the user computing device 130 is able to communicate with other devices connected to the user local network 105. For example, the user computing device 130 may communicate with a local device 150, such as a smart thermostat. As such, the user may activate an application associated with the local device 150 on the user computing device 130 and provide various inputs (e.g., temperature preferences) to control the local device 150 via the user local network 105.

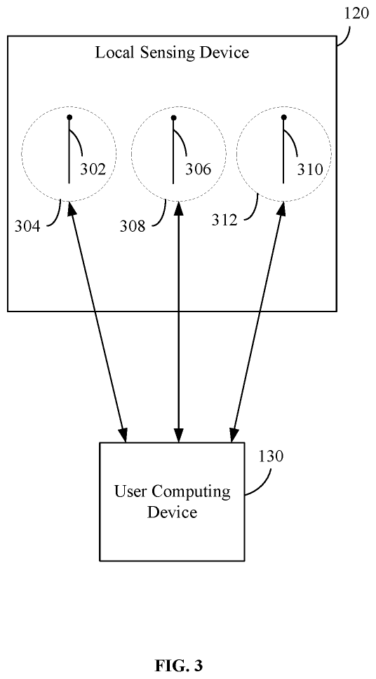

Referring now to FIG. 3, an exemplary implementation of a the LS device 120 is shown according to an example embodiment. The LS device 120 includes a first sensing device 302, a second sensing device 306, and a third sensing device 310. Each sensing device 302, 306, and 310 may be or include a beacon that emits a low-energy radio frequency signal including a unique beacon identifier in a corresponding limited geographical range 304, 308, and 312. It should be noted that each beacon 302, 306, and 310 includes a network circuit 122 enabling the beacon to communicate information over the network 160 as well as a LS I/O device 126 as discussed above in relation to FIG. 2, but these are not shown in FIG. 3 for illustrative purposes. In some arrangements, each beacon 302, 306, and 310 includes a GPS sensor (not shown) configured to detect the location of each corresponding beacon. In some arrangements, each beacon 302, 306, and 310 is configured to transmit a unique beacon identifier as well as location data generated by the GPS sensor over the network 160 (e.g., by the LS network circuit 122) to the network security computing system 140. The network security computing system 140 and/or network agent 110 is configured to store location information in the user database 144 in association with the beacon identifier.

In operation, if the user locates the user computing device 130 such that it is within the limited geographical range 304 of the low-energy signal broadcasted by the first beacon 302, the user computing device 130 (e.g., by the user I/O device 136) may become communicatively coupled to the first beacon 302. The first beacon 302, responsive to becoming communicatively coupled to the user computing device 130, may be configured to transmit a notification to the network security computing system 140 and/or network agent 110 indicating that the first beacon 302 is in communication with the user computing device 130. Thus, since the location information of the first beacon 302 is stored in the user database 144, the network security computing system 140 is aware of a precise location of the user computing device 130 upon receiving the notification. A similar process may be repeated with respect to the second and third beacons 306 and 310.

In some arrangements, the user may set a beacon sequence as a non-alphanumeric passkey. In other words, in order to connect to the user local network 105, the user would bring the user computing device 130 within the limited geographic ranges 304, 308, and 312 in a specific sequence. For example, a user may set a beacon sequence of “3121” as a non-alphanumerical passkey. In this example, to connect to the user local network 105, the user would have to bring the user computing device 130 first into the limited range 312 of the third beacon 310, then bring the user computing device 130 into the limited range 304 of the first beacon 302, then bring the user computing device 130 into the limited range 308 of the second beacon 306, and then bring the user computing device 130 into the limited range 304 of the first beacon 302. This would cause the network security computing system 140 to determine a location sequence of the user computing device 130 that matches the non-alphanumerical passkey.

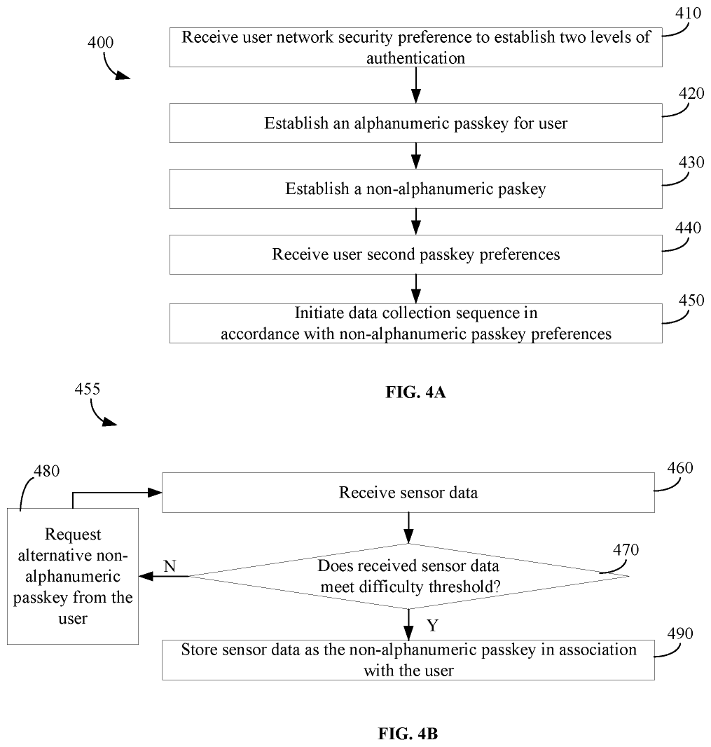

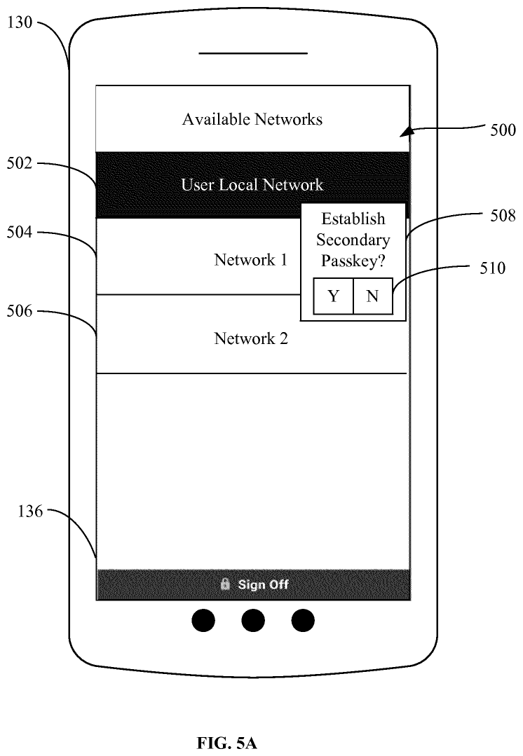

Referring now to FIG. 4A, a flow chart of a method 400 for establishing a non-alphanumeric passkey as a secondary authentication level is shown according to an example embodiment. The method 400 may be performed by processing and storage hardware of the user computing device 130.

At 410, a user network security preference to establish two levels of authentication is received. For example, the user may download the network security client application 134 and, while connected to the user local network 105, provide an input (e.g., via the user I/O device 136) to establish two levels of authentication for the user local network 105.

At step 420, an alphanumeric passkey is established for the user. For example, in response to the input received from the user at 410, program logic of the network security client application 134 may cause the user computing device 130 to present the user with another interface. The interface may prompt the user to input (e.g., via the user I/O device 136) and verify a sequence of symbols that are to be established as an alphanumeric passkey for the user local network 105. Once the user inputs and verifies a sequence of symbols, the user computing device 130 may be configured to transmit the received sequence of symbols to the network agent 110 and/or network security computing system 140. The network security management circuit 142 may then receive the alphanumeric passkey and store the passkey in the user database 144.

At step 430, a non-alphanumeric passkey is established. For example, upon receiving the user-input alphanumeric passkey, program logic of the network security client application 134 causes the user computing device 130 to present the user with another interface prompting the user to establish a secondary, non-alphanumerical passkey. The interface prompts the user to indicate a type of action that the user wishes to establish as a non-alphanumeric passkey (e.g., a sequence of movements, a sequence of sounds, etc.). Additionally, the interface may also prompt the user to identify a sensing device (e.g., a sensing device associated with the user computing device 130, the LS device 120, or the ES device 210) to generate the sensing data for the verified non-alphanumeric passkey. In this regard, program logic of the network security client application 134 may cause the user computing device 130 to identify any LS devices 120 connected to the user local network 105 and present the user with a list of such devices. For example, the user computing device 130 may receive a signal from the network agent 110 including the names of the various devices connected to the user local network 105. Upon receiving such a signal, the user computing device 130 may be configured to present the user with a list of connected devices, and the user may select the LS device 120 from the list.

At step 440, user preferences for the second passkey are received. For example, the user may input various preferences on interfaces presented at 430. The inputs may identify a type of action that the user wishes to establish as a non-alphanumeric passkey and the sensing device that the user wishes to utilize for network verification.

At step 450, a data collection sequence is initiated. In some arrangements, program logic of the network security client application 134 executed by the user computing device 130 causes the user computing device 130 to activate any sensing devices identified by the inputs received at 440. To illustrate, a user indicates a preference to establish a movement sequence as a non-alphanumeric passkey and to use an accelerometer associated with the user computing device 130 to generate the sensing data. Responsive to receiving this preference, the network security client application 134 causes the accelerometer to monitor the user, and instruct the user to perform an action. As the user performs the action, the program logic of the network security client application 134 causes the user computing device 130 to store the sensor values generated by the accelerometer. Once the user completes the action, the network security client application 134 causes the user computing device 130 to request that the user re-perform the action for purposes of verification. If the second performance matches the first performance of the action (e.g., to a threshold percent or degree of accuracy) the user action is established as a non-alphanumeric passkey. As such, the network security client application 134 causes the user computing device 130 to transmit the generated data to the network agent 110 and/or network security computing system 140 to establish the generated data as a verified non-alphanumerical passkey.

In another example, the user computing device 130 may communicate with other sensing devices via the user local network 105 and/or network 160. For example, if the user, via the inputs received at 440, indicates a preference to have a LS device 120 monitor the user while the user performs the action, the network security client application 134 may cause the user computing device 130 to communicate with the LS device 120 via the user local network 105. The user computing device 130 may be configured to transmit instructions to the LS device 120 over the user local network 105 that cause the LS device 120 to begin capturing data. Alternatively, the user may manually activate the LS device 120, and the LS device 120 may transmit any generated data to the network agent 110 and/or network security computing system 140 for further processing.

In some arrangements, the identified sensors may be associated with the network security computing system 140 (e.g., an ES device 210). In such arrangements, upon the user selecting such a sensor (e.g., via the interfaces presented to the user at 430), the network security client application 134 may cause the user computing device 130 to transmit a notification to the network security computing system 140. The notification may include a network identifier associated with the user local network 105 as well as location data describing the location of the user local network. Upon receiving the notification, the security management circuit 142 may be configured to transmit instructions including the location data and program logic to the ES device 210. The program logic may configure hardware associated with the ES device 210 to move the ES device 210 towards the identified location of the user local network 105, and instruct sensors 216 on the ES device 210 to begin monitoring the user upon the ES device 210 reaching the location. Once the ES device 210 finishes capturing data of the user, the data may be transmitted to back to the network security computing system 140 and/or network agent 110 for further processing and/or establishment as the user's non-alphanumeric passkey.

Referring now to FIG. 4B, a flow chart of a method 455 for verifying the eligibility of a set of sensor data for use as a non-alphanumeric passkey is shown, according to an example embodiment. The method 455 may be performed by processing and storage hardware of the network security computing system 140. It should be noted that the method 455 may also be performed by processing and storage hardware on the network agent 110 such that, with reference to the description herein, any function performed by the network security computing system 140 may also be performed by the network agent 110. In some arrangements, the method 455 is initiated responsive to the process 400 being completed by the user computing device 130.

At 460, sensor data is received. In some arrangements, the various sensing devices activated at 450 (e.g., sensors associated with the user computing device 130, sensors 124 of the LS device 120, or sensors 216 of the ES device 210) may be configured to transmit generated sensing data to the network agent 110, which in turn may transmit the generated data to the network security computing system 140 over the network 160.

At 470, it is determined if the received sensor data meets a difficulty or uniqueness or level of security threshold. In some arrangements, the security management circuit 142 is configured to compare the sensor data received at 460 to the general non-alphanumeric passkey information stored in the user database 144. For example, if the received sensor data includes a sequence of sounds generated by a microphone, the security management circuit 142 may be configured to compare the received microphone data to microphone data stored in the user database 144 that corresponds to various sounds that were pre-determined to be easy to guess (e.g., monotones, single common words such as “hello,” common songs, and the like). In some arrangements, if a match is found between the received microphone data and general information stored in the user database 144, the security management circuit 142 may be configured to transmit a request for the user to establish a different non-alphanumeric passkey to the user computing device 130 over the network 160 at 480. In response to receiving this request, the network security client application 134 may configure the user computing device 130 to present the user with another interface requesting the user make a different set of sounds. In some arrangements, the steps 460, 470, and 480 are repeated until the network security management circuit 142 receives a set of sensor data that does not correspond to any of the general non-alphanumeric passkey information stored in the user database 144.

At 490, the received sensor data is stored as a non-alphanumeric passkey. In some arrangements, the security management circuit 142 stores the received sensor data in association with the unique network identifier associated with the user local network 105 in the user database 144. Once stored, the received sensor data is used to authenticate users of the user local network 105, for example, according to the methods described in greater detail herein.

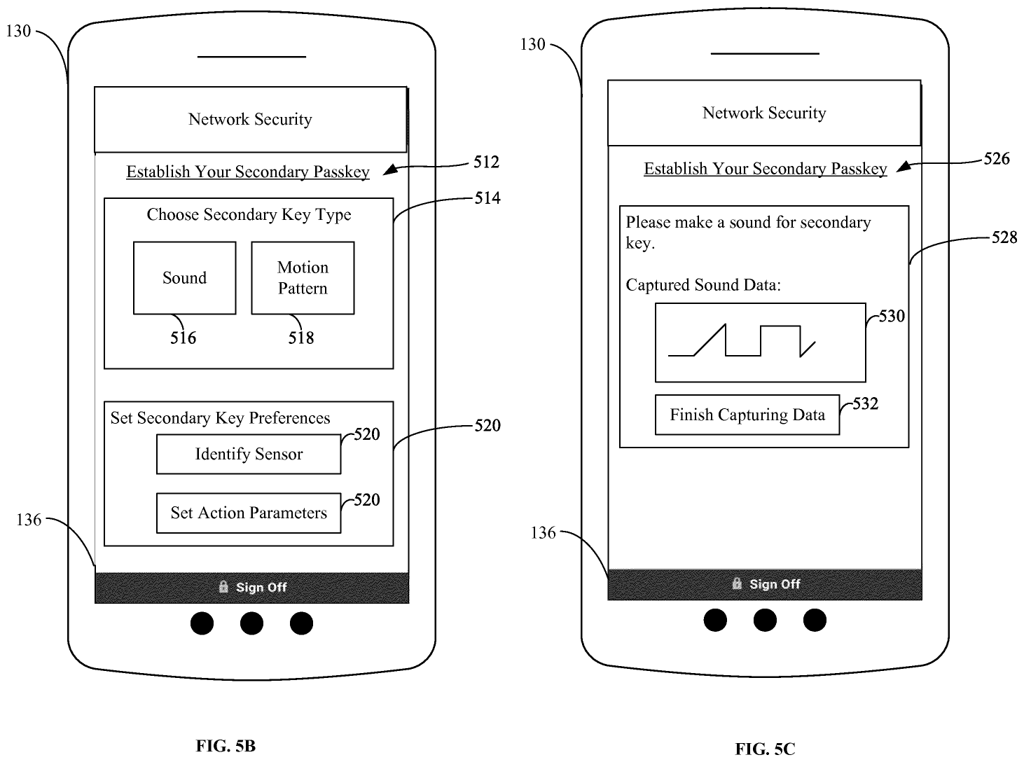

Referring now to FIG. 5A, an example interface 500 is shown. In some arrangements, the interface 500 is displayed on the user I/O device 136 of the user computing device 130. In some arrangements, the interface 500 is shown when the user computing device 130 includes the network security client application 134 and the user seeks to establish a connection to the user local network 105. The interface 500 includes first network button 502, a second network button 504, and a third network button 506. In some arrangements, the content displayed by the network buttons 502, 504, and 506 is dependent on wireless signals being received by the user computing device 130 (e.g., via the user network circuit 132). As shown, the first network button 502 identifies the user local network 105. Thus, in the example shown, the user computing device 130 receives the wireless network signal broadcasted by the network agent 110. In some arrangements, responsive to the user computing device being connected to the user local network 105, the network security client application 134 is configured to present a secondary passkey window 508 to the user. The secondary passkey window 508 includes a preference button 510 that enables the user to indicate whether they wish to establish a secondary passkey for the user local network. In some arrangements, the method 400 discussed above in relation to FIG. 4A is initiated responsive to the user indicating they wish to establish a secondary passkey.

Referring now to FIG. 5B, an example interface 512 is shown. In some arrangements, the interface 512 is displayed on the user I/O device 136 of the user computing device 130. In some arrangements, the interface 512 is presented on the user I/O device 136 at step 430 of the method 400 for establishing a secondary non-alphanumeric passkey discussed above. As shown, the interface 512 includes a secondary passkey type window 514 and a passkey preferences window 520. The secondary passkey type window 514 includes a first type button 516 and a second type button 518, and each correspond to a different type of action that the user may take while being monitored by a sensing device (e.g., a sensor 124 of the LS device 120). By selecting either first type button 516 or the second type button 518, the user may indicate the type of action that is to be used as the secondary non-alpha-numeric passkey. The preferences window 520 enables the user to input preferences as to the secondary passkey. As shown, the preferences window 520 includes a sensor identification button 522 and an action parameter button 524. In some arrangements, responsive to the user selecting the sensor identification window 522 the user may be shown another interface identifying various sensing devices (e.g., sensing devices associated with the user computing device 130, LS devices 120 associated with the user local network 105, and ES devices 210), that the user may select to generate data to establish a secondary passkey. In some arrangements, responsive to the user selecting the action parameter button 524, the user may be shown another interface enabling the user to indicate preferences with respect to aspects of the customer action to be monitored by the sensing device. For example, if the user wishes to use a sequence of sounds as a secondary passkey, selection of the action parameter button 524 may enable the user to select an aspect of the sound sequence (e.g., frequency, volume, amplitude, or the like) that is to serve as the non-alphanumeric passkey. In some arrangements the network security client application 134 configures the user computing device 130 to transmit responses input by the user to the network security computing system 140 over the network 160.

Referring now to FIG. 5C, an example interface 526 is shown. In some arrangements, the interface 526 is displayed on the user I/O device 136 of the user computing device 130. In some arrangements, the interface 526 is presented on the user I/O device 136 at step 450 of the method 400 for establishing a secondary non-alphanumeric passkey discussed above. For example, if a user selects a sensing device associated with the user computing device 130 to generate data to create a secondary passkey, the network security client application 134 may be configured to cause the sensing device to begin capturing data and present the user with the interface 526. As shown, the interface 526 includes a passkey data window 528. The passkey data window 528 includes a data collection indicator 530 and a generate completion button 532. The data collection indicator 530 displays a visual depiction of the data that has been generated by the sensing device. For example, if the user selects (e.g., through the interface 512 shown in FIG. 5B) to use a sequence of sounds as a secondary passkey, and chooses to use the volume of the sequence of sounds as the secondary passkey, the data collection indicator 530 may include a graph of all of the sounds generated by the sensing device. The generate completion button 532 enables the user to deactivate the sensing device configured to generate data of the user's actions. Responsive to the user pressing the generate completion button 532, the network security client application 134 may be configured to store the data generated by the sensing devices or transmit the generated data to the network security computing system (e.g., via the network agent 110).

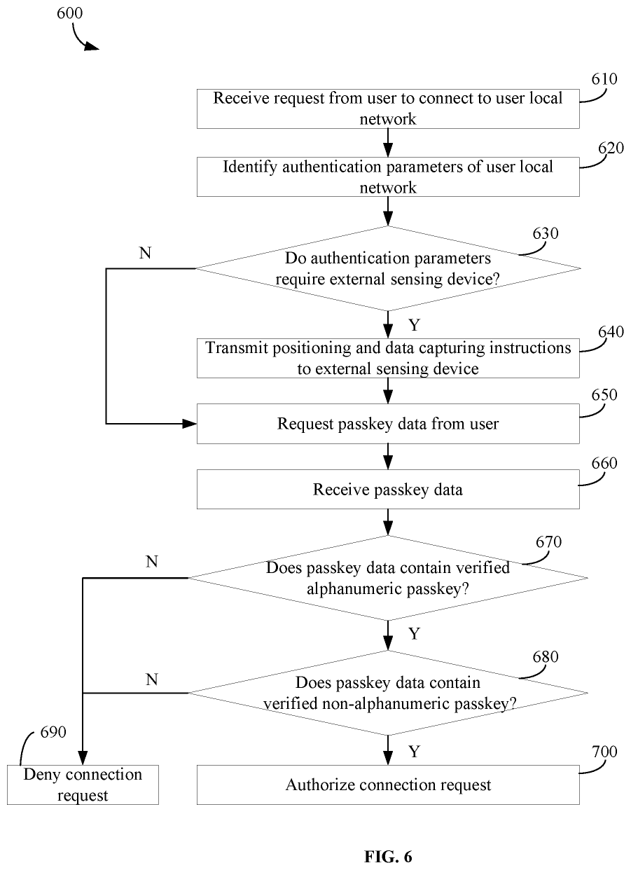

Referring now to FIG. 6, a method 600 of authorizing a user computing device 130 to connect to a network is shown according to an example embodiment. The method 600 may be performed by processing and storage hardware of network security computing system 140. It should be noted that the method 600 may also be performed by processing and storage hardware the network agent 110, such that, with reference to the description below, any function performed by the network security computing system may also be performed by the network agent.

At 610, a network connection request is received. In some arrangements, the connection request is received by the network agent 110 from the user computing device 130. For example, responsive to a user bringing the user computing device 130 into the range of a wireless signal broadcasted by the network agent 110, the network security client application 134 implemented on the user computing device 130 may present the user with an interface giving the user the ability to indicate a preference to connect to the user local network 105. Responsive to the user indicating such a preference, the network security client application 134 may configure the user computing device 130 to transmit a network connection request to the network agent 110, which may in turn transmit the network connection request to the network security computing system 140 over the network 160. In some arrangements, the network connection request may include a unique network identifier that is associated with the user local network 105.

At 620, authentication parameters are identified. In some arrangements, the network security management circuit 142 receives information contained in the network connection request received at 610, and retrieves authentication parameters stored in association with the user local network 105 from the user database 144. Authentication parameters may identify passkeys (e.g., both an alphanumeric and a non-alphanumeric passkey) associated with the user local network and the location of the user local network. Additionally, the parameters may identify sensing devices that are configured to generate data to authenticate the user.

At 630, it is determined if the authentication parameters require the ES device 210. As discussed herein, some embodiments may employ an ES device 210 associated with the network security computing system 140 that is capable of being positioned to generate data of the user. In some arrangements, the user may indicate a preference (e.g., during the method 400 discussed above in relation to FIG. 4) to cause the ES device 210 generate data of the user performing a predetermined action. The preference may be stored in the user database 144. Accordingly, the network security management circuit 142 may be configured to identify the preference. If the customer has not indicated such a preference, then the method 600 skips to step 650, which will be described in greater detail below.

However, if the user has indicated a preference for the ES device 210 to generate data of the user, instructions are transmitted to the ES device at 640. In some arrangements, the instructions include a series of radio control signals that configure associated hardware on the ES device 210 to reposition itself such that the ES device 210 may generate data of the user in proximity to the user local network 105. For example, the ES device 210 may include a radio controlled drone and the transmitted instructions may configure the hardware on the radio controlled drone to make a series of movements to reach the location of the user local network 105. In some arrangements, the instructions transmitted to the ES device 210 also include data capturing instructions. The data capturing instructions may identify sensors 216 of the ES device 210 that are to generate data once the ES device repositions itself to generate data of the location of the user local network 105. In some arrangements, once the ES device 210 repositions itself such that the sensors 216 are capable of capturing data of the user performing a predetermined action, the data capturing instructions activate the sensors 216 so that the sensors 216 begin capturing and storing data.

At 650, passkey data is requested from the user. In some arrangements, the security management circuit 142 is configured to transmit a passkey request to the user computing device 130 via the network agent 110. Upon receipt of the request, the network security client application 134 may cause the user computing device 130 to present the user with an interface prompting the user to input passkey data. In some arrangements, the content displayed by the interface is based on passkey data stored in the user database 144 in association with the user local network 105. For example, if both an alphanumeric passkey and a non-alphanumeric passkey is stored in association of the user local network 105, the interface presented to the user may request that the user input an alpha-numeric passkey (e.g., via the user I/O device 136) and a non-alphanumeric passkey. In this regard, the interface may enable the user to activate a sensing device (e.g., microphone, camera, accelerometer, or the like) associated with the user computing device 130. Additionally, the interface may also instruct the user to activate another sensing device (e.g., the LS device 120) or present the user with the ability to establish communications (e.g., via the user I/O device 136) with another sensing device (e.g., the LS device 120 via the LS I/O device 126). In some arrangements, where the ES device 210 monitors the user, for example, the interface presented to the user may only request the user to input an alphanumeric passkey.

At 660, user passkey data is received. In some arrangements, the user inputs an alphanumeric passkey into the user computing device 130 via the user I/O device 136, and the network security client application 134 configures the user computing device 130 to transmit the received alphanumeric passkey to the network security client application. In some arrangements, the user computing device 130 receives an input from the user on the interface presented to the user at 650. The interface may indicate a user preference to activate a sensing device. Accordingly, responsive to receiving the input, the network security client application 134 activates sensing devices (e.g., sensing devices associated with the user computing device 130 or an LS device 120 in communication with the user computing device 130) such that the sensing devices generate data of the user performing a predetermined action. For example, a microphone of the user computing device 130 may generate audio data of the user as the user makes a sequence of sounds. Once the user finishes performing the predetermined action, the network security client application 134 may configure the user computing device 130 to transmit the generated data to the network agent 110, which may in turn transmit the generated sensor data to the network security computing system 140. In some arrangements, sensors 216 on the ES device 210 generate data of the user performing the predetermined action and transmit the generated data to the network security computing system 140.

At 670, it is determined if the user entered the correct alphanumeric passkey. In some arrangements, the network security management circuit 142 is configured to compare the alphanumeric passkey entered by the user with stored alphanumeric passkey information stored in the user database. If the input alphanumeric passkey does not match the stored alphanumeric passkey, then the request to connect to the user local network 105 is denied at 690.

At 680, it is determined if the user performed a predetermined action that has been established as a non-alphanumeric passkey for the user local network 105. In some arrangements, the network security management circuit 142 is configured to compare the received sensor data with verified sensor data (e.g., generated during the method 400 discussed above in relation to FIG. 4) stored in the user database 144. If the received sensor data does not match the verified sensor data, then the request to connect to the user local network 105 is denied at 690.

At 700, the request to connect to the user local network 105 is authorized. In some arrangements, responsive to determining that the user input the correct alphanumeric passkey and received the verified sensor data stored in association with the user local network 105 in the user database 144, the network security management circuit 142 is configured to transmit instructions to the network agent 110 over the network 160. The instructions may configure the network agent (e.g., via the network control circuit 114) to establish full communications with the user computing device 130 via the access point 116, thus enabling the user computing device 130 to communicate with other devices connected with the user local network 105.

The embodiments described herein have been described with reference to drawings. The drawings illustrate certain details of specific embodiments that implement the systems, methods, and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input device,” as described herein, may include any type of input device or input devices including, but not limited to, a keyboard, a keypad, a mouse, joystick, or other input devices capable of performing a similar function. Comparatively, the term “output device,” as described herein, may include any type of output device or output devices including, but not limited to, a computer monitor, printer, facsimile machine, or other output devices capable of performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described to explain the principals of the disclosure and its practical application to enable one skilled in the art to utilize the various embodiments and with various modifications as are suited to the particular use contemplated. Other substitutions, modifications, changes, and omissions may be made in the design, operating conditions, and arrangement of the embodiments without departing from the scope of the present disclosure as expressed in the appended claims.

1. A network security computing system comprising:
a network circuit configured to enable the network security computing system to exchange information over a network;
a user database configured to store network security information for a plurality of users; and
a network security circuit configured to:
receive a request to connect to a local network from a user computing device associated with a user;
receive, from a first device, first authentication data comprising an alphanumeric passkey;
receive, from a second device separate from the first device, second authentication data related to a user performing a physical action;
authenticate the request by comparing the first and second authentication data with verified passkey data stored in the user database and determining that the alphanumeric passkey corresponds to a predetermined alphanumeric passkey and that the physical action corresponds to a predetermined physical action; and
authorize connection of the user computing device to the local network based at least in part on the request being authenticated.

2. The network security computing system of claim 1, wherein the second authentication data includes sound data generated by a microphone.

3. The network security computing system of claim 1, wherein the second authentication data includes accelerometer data generated by an accelerometer.

4. The network security computing system of claim 1, wherein the second authentication data includes image data generated by a camera.

5. The network security computing system of claim 1, wherein the first device is the user computing device associated with the user, and wherein the first authentication data is manually entered by the user into the user computing device in response to a prompt.

6. The network security computing system of claim 1, wherein the request to connect to the local network includes a location of the user computing device, and the network security circuit is further configured to position a sensing device to monitor the location of the user computing device.

7. The network security computing system of claim 6, wherein the sensing device monitors at least a first portion of the physical action.

8. The network security computing system of claim 7, wherein a user sensing device associated with the user computing device monitors a second portion of the physical action and transmits data regarding the second portion to the network security computing system.

9. The network security computing system of claim 1, wherein the network circuit is further configured to:
transmit over the network a network security software application to the user computing device, the network security software application configured to communicatively couple the user computing device to the network security computing system;
receive over the network an input from the user computing device to establish a non-alphanumeric passkey;
receive over the network data related to the user performing a provisional physical action; and
store the received data related to the user performing the provisional physical action in the user database as the predetermined action.

10. The network security computing system of claim 9, wherein the user database is configured to store invalid non-alphanumeric passkeys, and the network circuit is further configured to:
determine that the received data related to the user performing the provisional physical action corresponds an invalid non-alphanumeric passkey; and
transmit, over the network via the network circuit, responsive to determining that the received data related to the user performing the provisional physical action corresponds to an invalid non-alphanumeric passkey, a prompt to the user computing device instructing the user to perform a different provisional physical action.

11. A computer-implemented method, the method comprising:
receiving, by a network security computing system, a request to connect to a local network from a user computing device associated with a user;
receiving, by the network security computing system from a first device, first authentication data comprising an alphanumeric passkey;
receiving, by the network security computing system from a second device separate from the first device, second authentication data related to a user performing a physical action;
authenticating, by the network security computing system, the request by comparing the first and second authentication data with verified passkey data stored in a user database and determining that the alphanumeric passkey corresponds to a predetermined alphanumeric passkey and that the physical action corresponds to a predetermined physical action; and
authorizing, by the network security computing system, connection of the user computing device to the local network based at least in part on the request being authenticated.

12. The method of claim 11, wherein the second authentication data includes sound data generated by a microphone.

13. The method of claim 11, wherein the second authentication data includes accelerometer data generated by an accelerometer.

14. The method of claim 11, wherein the second authentication data includes image data generated by a camera.

15. The method of claim 11, wherein the first device is the user computing device associated with the user, and wherein the first authentication data is manually entered by the user into the user computing device in response to a prompt.

16. The method of claim 11, wherein the request to connect to the local network includes a location of the user computing device, and the method further comprises positioning, by the network security computing system, a sensing device to monitor the location of the user computing device.

17. The method of claim 16, wherein the sensing device monitors at least a first portion of the physical action.

18. The method of claim 17, wherein a user sensing device associated with the user computing device monitors a second portion of the physical action and transmits data regarding the second portion to the network security computing system.

19. A non-transitory computer readable media having computer-executable instructions embodied therein that, when executed by a network security circuit of a network security computing system, causes the network security computing system to perform operations to authorize a request to connect to a local network, the operations comprising:
receiving a request to connect to a local network from a user computing device associated with a user;
receiving, from a first device, first authentication data comprising an alphanumeric passkey;
receiving, from a second device separate from the first device, second authentication data related to a user performing a physical action;
authenticating the request by comparing the first and second authentication data with verified passkey data stored in a user database and determining that the alphanumeric passkey corresponds to a predetermined alphanumeric passkey and that the physical action corresponds to a predetermined physical action; and
authorizing connection of the user computing device to the local network based at least in part on the request being authenticated.

20. The non-transitory computer readable media of claim 19, wherein the second authentication data includes at least one of the following: sound data generated by a microphone, data generated by an accelerometer, and image data generated by a camera.

21. The non-transitory computer readable media of claim 19, wherein the physical action comprises a first distance traveled in a first direction, and a second distance traveled in a second direction.

22. The non-transitory computer readable media of claim 19, wherein the physical action comprises a first number of steps traveled in a first direction, and a second number of steps traveled in a second direction.

23. The non-transitory computer readable media of claim 19, wherein the physical action comprises moving to a particular location.

24. The non-transitory computer readable media of claim 23, wherein the particular location is a first particular location, and wherein the physical action further comprises remaining at the first particular location for a minimum amount of time and then moving to a second particular location.

25. The non-transitory computer readable media of claim 23, wherein the physical action further comprises making particular sounds while moving to the particular location, the particular sounds comprising at least one of a phrase, a chant, and a melody.
